(19) United States
(12) Patent Application Publication
(10) Pub. No.: US 2022/0366728 A1
(43) Pub. Date: Nov. 17, 2022

(54) ACCOUNTING APPARATUS, ACCOUNTING METHOD, AND NON-TRANSITORY STORAGE MEDIUM

(71) Applicant: NEC Corporation, Minato-ku, Tokyo (JP)

(72) Inventors: Jun MORIZONO, Tokyo (JP); Jiroh KUBOTA, Tokyo (JP)

(73) Assignee: NEC Corporation, Minato-ku, Tokyo (JP)

(21) Appl. No.: 17/623,368

(22) PCT Filed: Jul. 3, 2020
(86) PCT No.: PCT/JP2020/026175

§ 371 Date: Dec. 28, 2021

(30) Foreign Application Priority Data
Jul. 9, 2019 (JP) 2019-127813

(51) Int. Cl. G07B 15/00; G06Q 20/28

(52) U.S. Cl. CPC G07B 15/00; G06Q 20/28

(57) ABSTRACT

The present invention provides an accounting apparatus (100) including: an input information acquisition unit (13) that acquires apparatus identification information stored in an electronic money information storage apparatus; a prepayment process execution unit (16) that executes a prepayment process in which a predetermined amount is subtracted from an electronic money balance, based on electronic money information stored in the electronic money information storage apparatus; a registration unit (14) that registers, when a prepayment amount exceeds an accounting amount, a carried over amount being an excess amount and the apparatus identification information, in association with each other; and an accounting unit (18) that performs an accounting process in which the carried over amount in such a way as to be visually recognizable for a user.

### TECHNICAL FIELD

The present invention relates to an accounting apparatus, an accounting method, and a program.

### BACKGROUND ART

A technique related to the present invention is disclosed in Patent Documents 1 and 2.

Patent Document 1 discloses a technique of withdrawing a prepayment amount from an IC card at an entrance of a parking lot, registering the prepayment amount together with a vehicle identifier (ID), an IC card ID, and an entry time, acquiring only the vehicle ID by wireless communication at an exit of the parking lot and computing a parking fee, registering an amount acquired by subtracting the parking fee from the prepayment amount as a deposit, and refunding the deposit to the IC card at the entrance in a next time of use.

Patent Document 2 includes a measurement unit for determining an entry date and time, based on a vehicle entry signal, and measuring a parking time from the entry date and time, a reading unit for reading a vehicle number from a vehicle image, a recording unit for recording the vehicle number, the vehicle image, and the entry date and time, in association with one another, a panel unit including an operation unit for an input operation and a display unit for displaying the vehicle number and the vehicle image, a settlement unit for settling a parking fee, a first control unit for performing a settlement based on the vehicle number, and a second control unit for performing a settlement based on the entry date and time. The first control unit displays a plurality of images, based on an input vehicle number, and the second control unit displays a plurality of images, based on an input entry date and time, and thereby helps determine whether a vehicle to be settled is correct or not.

### RELATED DOCUMENT

### Patent Document

[Patent Document 1] Japanese Patent Application Publication No. 2008-152588
[Patent Document 2] Japanese Patent Application Publication No. 2018-22366

### Disclosure of The Invention

### Technical Problem

In some cases, an accounting amount is determined in response to contents of use and is not determined at a beginning of use. Examples include, but are not limited to, a parking lot, a rental office, a shared bicycle, and a shared car where an accounting amount is determined in response to a duration of use, a battery charge service where an accounting amount is determined in response to a charged amount, a restaurant where an accounting amount is determined in response to contents of an order, an amusement such as bowling where an accounting amount is determined in response to the number of games and the like, a supermarket and a convenience store where an accounting amount is determined in response to contents of a purchase, a vending machine for beverages and the like, a gas station, and the like.

In such a case, it is common to perform accounting after an end of use when an accounting amount is determined. However, some users would like to perform accounting at a beginning of use, in order to, for example, avoid waiting in line for accounting. In order to perform accounting at a beginning of use when an accounting amount is not determined, some kind of scheme is required.

According to the “technique of asking a user to prepay a fee, registering an amount acquired by subtracting a determined fee from a prepayment amount as a deposit, and refunding the deposit at a next time of use” disclosed in Patent Document 1, the above-described problem can be solved. However, in a case where the technique described in Patent Document 1 is used, a user is not able to recognize an existence and an amount of a deposit until the deposit is refunded. Therefore, a user is not able to manage a deposit, which is not convenient. Patent Document 2 neither describes nor suggests a technical concept and a challenge related to prepayment of a usage fee.

A problem of the present invention is to improve convenience in a technique of asking a user to prepay a usage fee and registering a carried over amount acquired by subtracting an accounting amount from a prepayment amount.

### Solution to Problem

According to the present invention,

an accounting apparatus including:

an input information acquisition means for acquiring apparatus identification information stored in an electronic money information storage apparatus;

a prepayment process execution means for executing a prepayment process in which a predetermined amount is subtracted from an electronic money balance, based on electronic money information stored in the electronic money information storage apparatus;

a registration means for registering, when a prepayment amount exceeds an accounting amount, a carried over amount being an excess amount and the apparatus identification information, in association with each other; and

an accounting means for performing an accounting process in which the carried over amount is output in such a way as to be visually recognizable for a user is provided.

Further, according to the present invention,

an accounting method including:

by a computer,

acquiring apparatus identification information stored in an electronic money information storage apparatus;

executing a prepayment process in which a predetermined amount is subtracted from an electronic money balance, based on electronic money information stored in the electronic money information storage apparatus;

registering, when a prepayment amount exceeds an accounting amount, a carried over amount being an excess amount and the apparatus identification information, in association with each other; and

performing an accounting process in which the carried over amount is output in such a way as to be visually recognizable for a user is provided.

Further, according to the present invention,

a program that causes a computer to function as

an input information acquisition means for acquiring apparatus identification information stored in an electronic money information storage apparatus,

a prepayment process execution means for executing a prepayment process in which a predetermined amount is subtracted from an electronic money balance, based on electronic money information stored in the electronic money information storage apparatus,

a registration means for registering, when a prepayment amount exceeds an accounting amount, a carried over amount being an excess amount and the apparatus identification information, in association with each other, and

an accounting means for performing an accounting process in which the carried over amount is output in such a way as to be visually recognizable for a user is provided.

### Advantageous Effects of Invention

According to the present invention, convenience in a technique of asking a user to prepay a usage fee and registering a carried over amount acquired by subtracting an accounting amount from a prepayment amount is improved.

### BRIEF DESCRIPTION OF THE DRAWINGS

FIG. 1 is one example of a functional block diagram of an accounting apparatus according to a present example embodiment.

FIG. 2 is a diagram illustrating one example of a hardware configuration of the accounting apparatus according to the present example embodiment.

FIG. 3 is a flowchart illustrating one example of a flow of processing achieved by the accounting apparatus according to the present example embodiment.

FIG. 4 is a flowchart illustrating one example of a flow of processing achieved by the accounting apparatus according to the present example embodiment.

FIG. 5 is a flowchart illustrating one example of a flow of processing achieved by the accounting apparatus according to the present example embodiment.

FIG. 6 is an example of a screen achieved by the accounting apparatus according to the present example embodiment.

FIG. 7 is an example of a screen achieved by the accounting apparatus according to the present example embodiment.

FIG. 8 is an example of a screen achieved by the accounting apparatus according to the present example embodiment.

FIG. 9 is a diagram schematically illustrating one example of information to be processed by the accounting apparatus according to the present example embodiment.

FIG. 10 is a diagram schematically illustrating one example of information to be processed by the accounting apparatus according to the present example embodiment.

FIG. 11 is a diagram schematically illustrating one example of information to be processed by the accounting apparatus according to the present example embodiment.

FIG. 12 is one example of a functional diagram of the accounting apparatus according to the present example embodiment.

FIG. 13 is an example of a screen achieved by the accounting apparatus according to the present example embodiment.

### DESCRIPTION OF EMBODIMENTS

### First Example Embodiment

First, an outline of an accounting apparatus according to the present example embodiment is described. The accounting apparatus according to the present example embodiment is suitable for use in a store and a facility where an accounting amount is determined in response to contents of use and is not determined at a beginning of use. Examples of such a store and facility include, but are not limited to, a parking lot, a rental office, a shared bicycle, and a shared car where an accounting amount is determined in response to a duration of use, a battery charge service where an accounting amount is determined in response to a charged amount, a restaurant where an accounting amount is determined in response to contents of an order, an amusement such as bowling where an accounting amount is determined in response to the number of games and the like, a supermarket and a convenience store where an accounting amount is determined in response to contents of a purchase, a vending machine for beverages and the like, a gas station, and the like.

The accounting apparatus according to the present example embodiment executes a prepayment process for a predetermined amount at a beginning of use (e.g., at a beginning of use of a parking lot), and registers a prepayment amount, in association with a user. Then, the accounting apparatus according to the present example embodiment compares the prepayment amount and a determined accounting amount at an end of use (e.g., at an end of use of the parking lot), and, when the prepayment amount exceeds the determined accounting amount, registers a carried over amount being an excess amount, in association with the user, and outputs (e.g., displays on a screen) the carried over amount in such a way as to be visually recognizable for the user. According to such an accounting apparatus according to the present example embodiment, a user is able to recognize an existence and an amount of a deposit by visually recognize the output carried over amount.

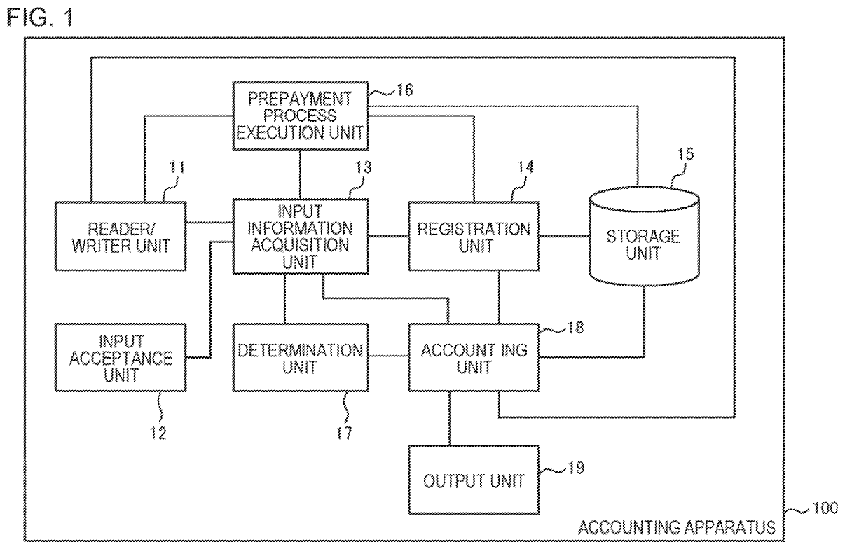

Next, a configuration of the accounting apparatus according to the present example embodiment is described in detail. FIG. 1 illustrates one example of a functional block diagram of an accounting apparatus 100. As illustrated in FIG. 1, the accounting apparatus 100 includes a reader/writer unit 11, an input acceptance unit 12, an input information acquisition unit 13, a registration unit 14, a storage unit 15, a prepayment process execution unit 16, a determination unit 17, an accounting unit 18, and an output unit 19.

The accounting apparatus 100 may be configured of a single apparatus that is physically and/or logically integrated, or may be configured of a plurality of apparatuses that are physically and/or logically separated. For example, the accounting apparatus 100 may be achieved by a terminal being installed in a store, a facility, and the like and operated by a user, and a server in communication with the terminal. In addition, the accounting apparatus 100 may be achieved by a single terminal being installed in a store, a facility, and the like and operated by a user. The following description is based on a premise that the accounting apparatus 100 is achieved by a single terminal being installed in a store, a facility, and the like and operated by a user.

Each of the above-described functional units included in the accounting apparatus 100 is achieved by any combination of hardware and software, mainly a central processing unit (CPU) of any computer, a memory, a program to be loaded into the memory, a storage unit (that is capable of storing, in addition to a program stored in advance from a stage of shipping an apparatus, a program downloaded from a storage medium such as a compact disc (CD), a server on the Internet, and the like) such as a hard disk in which the program is stored, and an interface for network connection. And it is understood by those skilled in the art that there are various modification examples of a method and an apparatus used for achieving each of the functional units.

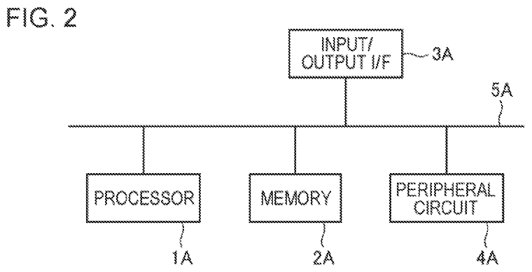

FIG. 2 is a block diagram illustrating a hardware configuration of the accounting apparatus 100. As illustrated in FIG. 2, the accounting apparatus 100 includes a processor 1A, a memory 2A, an input/output interface 3A, a peripheral circuit 4A, and a bus 5A. The peripheral circuit 4A includes various modules. Note that, the accounting apparatus 100 may not include the peripheral circuit 4A. Note that, in a case where the accounting apparatus 100 is configured of a plurality of apparatuses that are physically and/or logically separated, each of the plurality of apparatuses may have the above-described hardware configuration.

The bus 5A is a data transmission path for the processor 1A, memory 2A, the peripheral circuit 4A, and the input/output interface 3A to transmit/receive data mutually. For example, the processor 1A is an arithmetic operation apparatus such as a CPU, a graphics processing unit (GPU), and the like. The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, external apparatus, external server, and the like, and the like. The input apparatus is, for example, a keyboard, a mouse, a microphone, a touch panel, a physical button, a camera, and the like. The output apparatus is, for example, a display, a speaker, a printer, a mailer, and the like. The processor 1A is capable of instructing each module, and performing an arithmetic operation, based on an arithmetic operation result of each module.

Next, again with reference to FIG. 1, a configuration of each of the functional units is described.

The reader/writer unit 11 performs short-range wireless communication with an electronic money information storage apparatus, and thereby acquires and updates information stored in the electronic money information storage apparatus. The electronic money information storage apparatus is a portable apparatus having a function of storing electronic money information and a function of performing short-range wireless communication, and is exemplified by an IC card, an IC tag, a smartphone, a mobile phone, a tablet terminal, a smartwatch, and the like, but is not limited thereto. Note that, hereinafter, a case where the electronic money information storage apparatus is an IC card is described as an example.

The input acceptance unit 12 accepts an input of various types of information from a user via an input apparatus. The input apparatus is exemplified by a touch panel, a physical button, a microphone, a keyboard, a mouse, and the like, but is not limited thereto.

The input information acquisition unit 13 acquires various types of information being input from the reader/writer unit 11 and input acceptance unit 12.

The registration unit 14 manages information stored in the storage unit 15. The management herein includes update, deletion, new registration, and the like.

The storage unit 15 stores various types of information.

The prepayment process execution unit 16 executes a prepayment process.

The determination unit 17 determines an accounting amount. For example, determination unit 17 determines an accounting amount, based on a duration of use, a charged amount, contents of an order, the number of games, contents of a purchase, and the like. Note that, the example given here is merely one example, and the determination unit 17 may determine an accounting amount, based on other information.

The accounting unit 18 performs an accounting process, based on an accounting amount determined by the determination unit 17 and a prepayment amount in the prepayment process.

The output unit 19 outputs various types of information via any output apparatus such as a display, a speaker, an alarm lamp, and a projection apparatus.

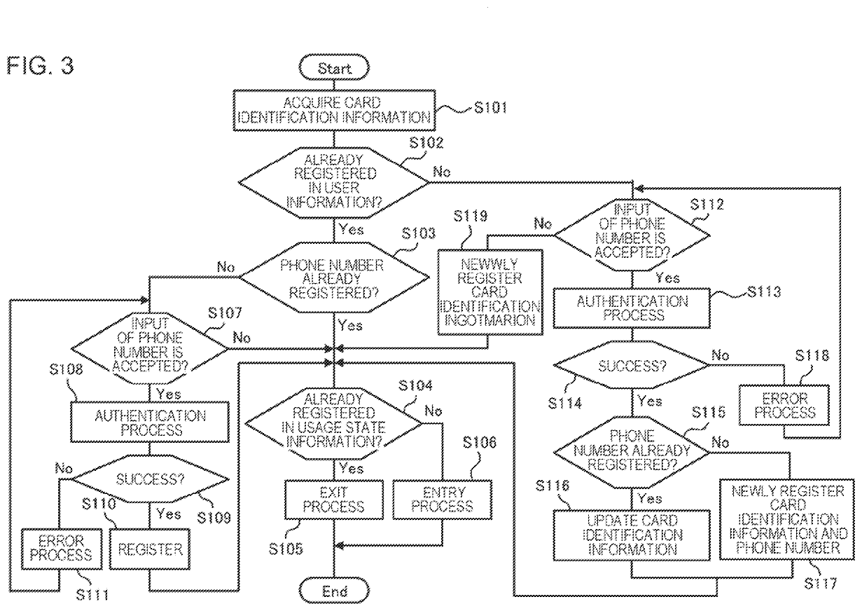

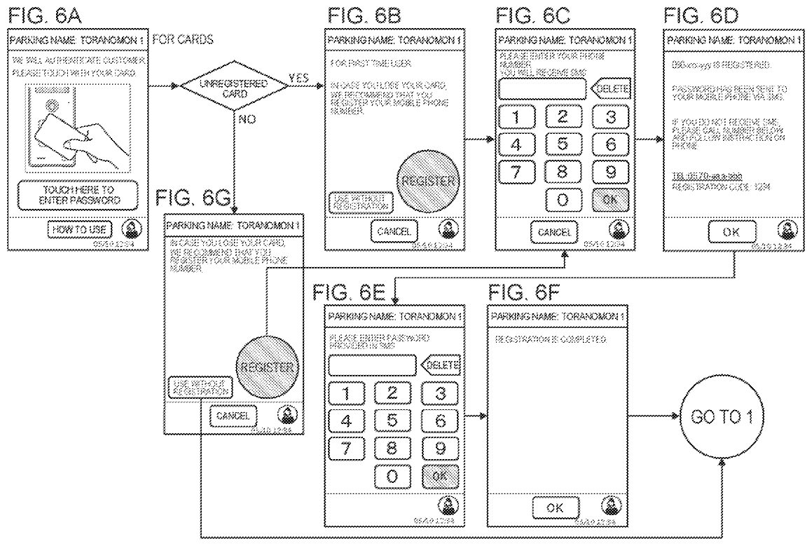

Next, one example of a flow of processing achieved by the above-described functional unit is described by using flowcharts in FIGS. 3 to 5 and screen examples in FIGS. 6 to 8. Herein, a case where the accounting apparatus 100 is used in a parking lot is described as an example. Further, the flow of processing is divided into a “process at a time of entry for a first time use”, a “process at a time of entry for a second time and subsequent use (using the same IC card as a previous time)”, a “process at a time of entry for a second time and subsequent use (using a different IC card from a previous time)”, and a “process at a time of exit”, and described.

“Process at a Time of Entry for a First Time Use” After parking a vehicle at any location in a parking lot, a user operates the accounting apparatus 100 installed at any location in the parking lot. The accounting apparatus 100 displays a screen in FIG. 6 (A), and is in an operation standby state. The user holds an IC card in which electronic money information to be used for payment is stored to a reader/writer of the accounting apparatus 100. Then, the input information acquisition unit 13 acquires, via the reader/writer unit 11, card identification information stored in the IC card (S101 in FIG. 3). The card identification information is one example of apparatus identification information stored in the electronic money information storage apparatus. The card identification information may be recorded on an IC chip to be mounted on the IC card, at a time of manufacturing the IC chip, and may be a non-rewritable unique number for the IC card. In addition, the card identification information may be user identification information of an electronic money service related to the electronic money information stored in the IC card. The user identification information of an electronic money service is information for identifying users of the electronic money service from each other.

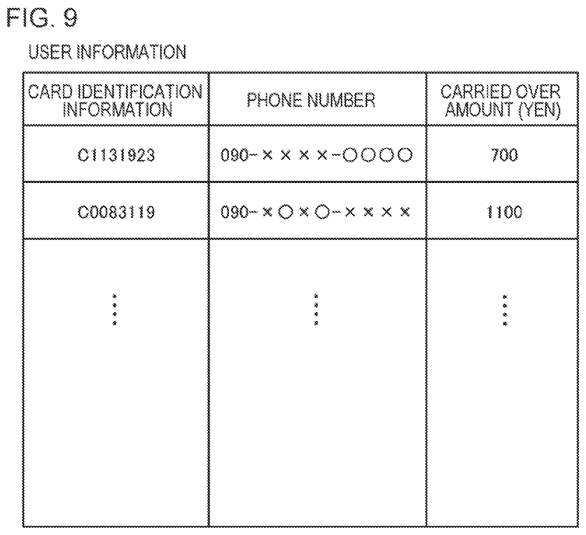

Next, the registration unit 14 determines whether the card identification information acquired in S101 has already been registered in user information (S102). The user information is information about a user who uses the parking lot, and is stored in at least either one of the storage unit 15 and a storage apparatus of a server configured in such a way as to be communicable with the accounting apparatus 100. One example of the user information is schematically illustrated in FIG. 9. In the illustrated user information, card identification information, a phone number, and an carried over amount are associated with one another. Note that, the illustrated user information is merely one example, and may further include another piece of information such as gender, date of birth, and the like.

In the case of first time use, the card identification information of the user is not registered in the user information. Therefore, S102 results in No, and the process proceeds to S112.

Next, as illustrated in FIG. 6 (B) and FIG. 6 (C), the accounting apparatus 100 displays a screen that prompts registration of a phone number of a mobile phone. Note that, registration of a phone number of a mobile phone is optional and is not necessary.

When an input of a phone number of a mobile phone is not accepted (No in S112), the registration unit 14 newly registers the card identification information acquired in S101 in the user information such as illustrated in FIG. 9 (S119). Next, the process proceeds to S104.

Meanwhile, when an input of a phone number of a mobile phone is accepted (Yes in S112), the input information acquisition unit 13 acquires the input phone number, in association with the card identification information acquired in S101. After that, an authentication process using a mobile phone is performed (S113). In the authentication process, issuing a password, transmitting the password by a short mail addressed to the accepted phone number of a mobile phone, accepting an input of the transmitted password, checking the issued password and the input password against each other, and the like are performed. These processes may be performed by the registration unit 14 or a sever configured in such a way as to be communicable with the accounting apparatus 100, or the registration unit 14 may perform some of the processes and a server may perform the other processes. Further, when a short mail does not reach, the authentication may be performed via a phone call. During these processes, the accounting apparatus 100 displays screens such as illustrated in FIG. 6 (D) and FIG. 6 (E).

When the authentication fails (No in S114), the registration unit 14 performs an error process (S118). For example, information indicating that the authentication has failed is displayed on a screen, a screen such as illustrated in FIG. 6 (C) is also displayed, and a re-input of the phone number is prompted. Then, the process returns to S112, and is repeated.

Meanwhile, when the authentication succeeds (Yes in S114), the registration unit 14 confirms whether the phone number accepted in S112 is registered in the user information such as illustrated in FIG. 9 (S115).

In the case of first time use, the phone number of the user is not registered in the user information. Therefore, S115 results in No, and the process proceeds to S117. In S117, the registration unit 14 newly registers, in the user information such as illustrated in FIG. 9, the card identification information acquired in S101 and the phone number accepted in S112, in association with each other. Note that, an initial value of a carried over amount is “0”. Then, the accounting apparatus 100 displays a screen such as illustrated in FIG. 6 (F).

By the processes up to this point, initial registration of information necessary for using the parking lot is completed. In an accounting service of the parking lot, the card identification information is information for identifying users who use the service from each other.

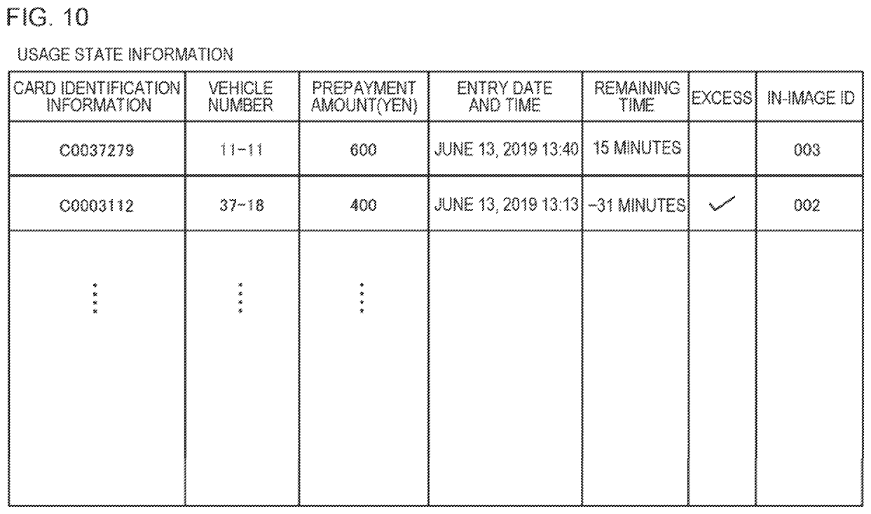

After that, in S104, the registration unit 14 determines whether the card identification information acquired in S101 has already been registered in usage state information. The usage state information is information indicating a usage state of the parking lot, and is stored in at least either one of the storage unit 15 and a storage apparatus of a server configured in such a way as to be communicable with the accounting apparatus 100. One example of the usage state information is schematically illustrated in FIG. 10. In the illustrated usage state information, card identification information, a vehicle number, a prepayment amount, an entry date and time, a remaining time, an excess flag, and an in-image ID are associated with one another. Note that, the usage state information may include another piece of information, and may not include some of the illustrated information.

In the case of a process at a time of entry, the card identification information is not registered in the usage state information. Therefore, S104 results in No, and the process proceeds to an entry process in S106.

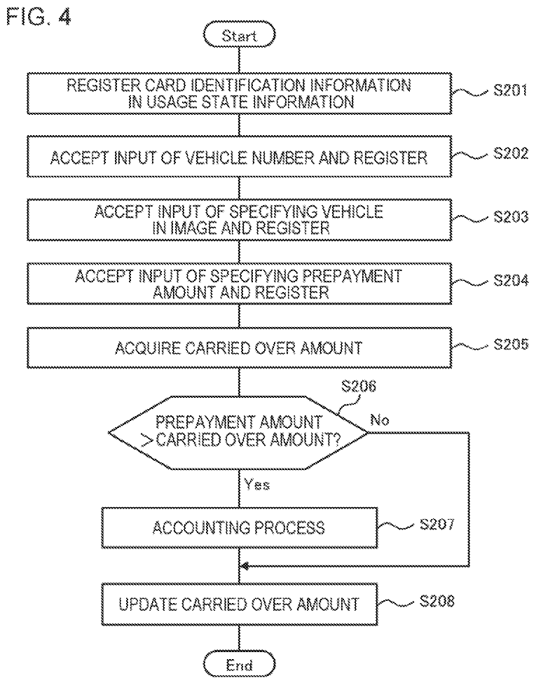

Next, a flow of the entry process in S106 is described by using a flowchart in FIG. 4.

The registration unit 14 registers the card identification information acquired in S101 in FIG. 3 in the use state information such as illustrated in FIG. 10 (S201).

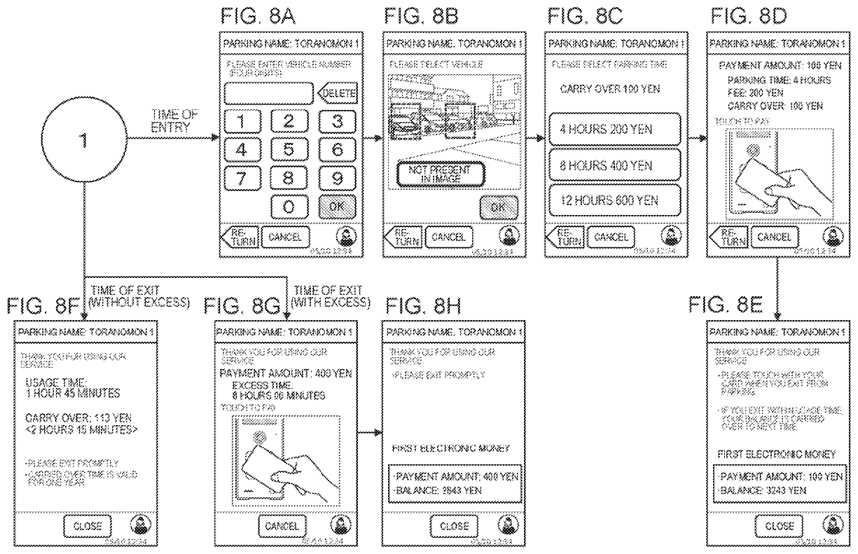

Next, the accounting apparatus 100 displays a screen such as illustrated in FIG. 8 (A), and prompts an input of a vehicle number. The input information acquisition unit 13 acquires, via the input acceptance unit 12, the input vehicle number (S202). Then, the registration unit 14 registers, in the use state information such as illustrated in FIG. 10, the acquired vehicle number, in association with the card identification information registered in S201 (S202).

Next, the accounting apparatus 100 displays a screen such as illustrated in FIG. 8 (B), and prompts an input that specifies a user's vehicle in the screen. For example, the accounting apparatus 100 analyzes an image, determines a vehicle present in the image, and displays a frame surrounding the determined vehicle. Then, the accounting apparatus 100 accepts an input that specifies any one of the displayed frames. Note that, the accounting apparatus 100 may display only a frame that surrounds a vehicle that is not specified yet among the determined vehicles.

The input information acquisition unit 13 acquires, via the input acceptance unit 12, information specifying any one of the vehicles in the image (S203). Then, the registration unit 14 registers, in the use state information such as illustrated in FIG. 10, information (an in-image ID) identifying the vehicle specified in the image, in association with the card identification information registered in S201 (S203). The in-image ID may be, for example, identification information of a frame surrounding each of the vehicles determined in the image.

Next, the accounting apparatus 100 displays a screen such as illustrated in FIG. 8 (C), and prompts an input that specifies a prepayment amount. The input information acquisition unit 13 acquires, via the input acceptance unit 12, the input prepayment amount (S203). Then, the registration unit 14 registers, in the use state information such as illustrated in FIG. 10, the acquired prepayment amount, in association with the card identification information registered in S201 (S204).

Next, the prepayment process execution unit 16 acquires, from the user information such as illustrated in FIG. 9, a carried over amount associated with the card identification information registered in S201 (S205).

Then, the prepayment process execution unit 16 executes a prepayment process. Specifically, when the prepayment amount specified in S204 exceeds the carried over amount acquired in S205 (Yes in S206), the prepayment process execution unit 16 executes the prepayment process (accounting process) in which a predetermined amount is subtracted from an electronic money balance, based on the electronic money information stored in the IC card (S208).

For example, the prepayment process execution unit 16 computes a predetermined amount (=prepayment amount−carried over amount), based on the prepayment amount specified in S204 and the carried over amount acquired in S205. Then, the accounting apparatus 100 displays, as illustrated in FIG. 8 (D), the computed predetermined amount (“payment amount” in FIG. 8 (D)), and also displays a screen that prompts holding the IC card to the reader/writer of the accounting apparatus 100. In response to this, when the IC card is held to the reader/writer of the accounting apparatus 100, and the accounting apparatus 100 and the IC card become a state in communicable, the prepayment process execution unit 16 updates, via the reader/writer unit 11, the electronic money information stored in the IC card, and subtracts the predetermined amount from the electronic money balance.

Then, the registration unit 14 updates, in the user information such as illustrated in FIG. 9, the carried over amount associated with the card identification information registered in S201 (S208). Specifically, an amount being used to pay for the prepayment amount is subtracted from the carried over amount. Note that, when the carried over amount is not used to pay for the prepayment amount, the carried over amount is not required to be updated.

Meanwhile, when the prepayment amount specified in S204 is less than the carried over amount acquired in S205 (No in S206), the prepayment process execution unit 16 executes the prepayment process for the prepayment amount, based on the carried over amount (S208). Specifically, the prepayment process execution unit 16 updates, in the user information such as illustrated in FIG. 9, the carried over amount associated with the card identification information registered in S201, via the registration unit 14 (S208). Specifically, an amount being used to pay for the prepayment amount is subtracted from the carried over amount. With the above-described processes, the process at a time of entry is completed. The accounting apparatus 100 displays, for example, a screen such as illustrated in FIG. 8 (E).

Note that, a processing order of S202 to S205 is not limited to a processing order illustrated in FIG. 4. Further, although not illustrated in FIG. 4, the registration unit 14 registers, at any timing, an entry date and time, in association with the card identification information registered in S201. The entry date and time is a time at any timing after the input of the card identification information is accepted in S101.

### “Process at a Time of Entry for a Second Time and Subsequent Use (Using the Same IC Card as a Previous Time)”

After parking a vehicle at any location in a parking lot, a user operates the accounting apparatus 100 installed at any location in the parking lot. The accounting apparatus 100 displays the screen in FIG. 6 (A), and is in the operation standby state. The user holds an IC card in which electronic money information to be used for payment is stored to the reader/writer of the accounting apparatus 100. Herein, it is assumed that the user holds the same IC card as a previous time when the user uses the parking lot to the reader/writer. Then, the input information acquisition unit 13 acquires, via the reader/writer unit 11, the card identification information stored in the IC card (S101 in FIG. 3).

Next, the registration unit 14 determines whether the card identification information acquired in S101 has already been registered in the user information (S102). In the case of a second time and subsequent use where the same IC card as a previous time of use is used, the card identification information of the user is registered in the user information. Therefore, S102 results in Yes, and the process proceeds to S103.

Next, the registration unit 14 determines whether a phone number is registered in association with the card identification information acquired in S101, in the user information such as illustrated in FIG. 9 (S103). When the phone number has already been registered (Yes in S103), the process proceeds to S104.

Meanwhile, when no phone number is registered (No in S103), the accounting apparatus 100 displays a screen that prompts registration of a phone number of a mobile phone, as illustrated in FIG. 6 (G). Note that, registration of a phone number of a mobile phone is optional and is not necessary.

When an input of a phone number of a mobile phone is not accepted (No in S107), the process proceeds to S104. Meanwhile, when an input of a phone number of a mobile phone is accepted (Yes in S107), the input information acquisition unit 13 acquires the input phone number, in association with the card identification information acquired in S101. After that, an authentication process using a mobile phone is performed (S108). Contents of the authentication process are similar to the authentication process in S113 described in the “process at a time of entry for a first time use”.

When the authentication fails (No in S109), the registration unit 14 performs the error process (S111). For example, information indicating that the authentication has failed is displayed on the screen, the screen such as illustrated in FIG. 6 (C) is also displayed, and a re-input of the phone number is prompted. Then, the process returns to S107, and is repeated.

Meanwhile, when the authentication succeeds (Yes in S109), the registration unit 14 registers, in the user information such as illustrated in FIG. 9, the input phone number, in association with the card identification information acquired in S101 (S110). Then, the process proceeds to S104.

In S104, the registration unit 14 determines whether the card identification information acquired in S101 has already been registered in the usage state information. In the case of the process at a time of entry, the card identification information is not registered in the usage state information. Therefore, S104 results in No, and the process proceeds to the entry process in S106. Contents of the entry process in S106 are similar to the entry process described in the “process at a time of entry for a first time use”.

“Process at a Time of Entry for a Second Time and Subsequent Use (Using a Different IC Card from a Previous Time)”

In the present example, it is assumed that an IC card (electronic money) different from a previous time when a user used the parking lot is used, due to any reason such as loss, expiration, non-possession, insufficient charged amount, and the like. As described above, in the accounting service of the parking lot, the card identification information is information for identifying users who use the service from each other. Therefore, when the IC card different from the previous time when the user used the parking lot is used, a carried over amount registered in association with the card identification information of the IC card used in the previous time when the user used the parking lot cannot be used. However, as apparent in the following description, a user who has registered a phone number of a mobile phone can use his/her own carried over amount, even in such case.

After parking a vehicle at any location in the parking lot, a user operates the accounting apparatus 100 installed at any location in the parking lot. The accounting apparatus 100 displays the screen in FIG. 6 (A), and is in the operation standby state. The user holds an IC card in which electronic money information to be used for payment is stored to the reader/writer of the accounting apparatus 100. Herein, it is assumed that the user holds an IC card different from the previous time when the user uses the parking lot to the reader/writer. Then, the input information acquisition unit 13 acquires, via the reader/writer unit 11, card identification information stored in the IC card (S101 in FIG. 3).

Next, the registration unit 14 determines whether the card identification information acquired in S101 has already been registered in the user information (S102). When the user uses the parking lot for a second time and subsequent and uses the IC card different from a previous time when the user uses the parking lot, the card identification information of the user is not registered in the user information. Therefore, S102 results in No, and the process proceeds to S112.

Next, as illustrated in FIG. 6 (B) and FIG. 6 (C), the accounting apparatus 100 displays a screen that prompts registration of a phone number of a mobile phone. Note that, registration of a phone number of a mobile phone is optional and is not necessary.

When an input of a phone number of a mobile phone is not accepted (No in S112), the registration unit 14 newly registers the card identification information acquired in S101 in the user information such as illustrated in FIG. 9 (S119). Next, the process proceeds to S104. In this case, the card identification information of the IC card of the present time of use is registered separately from the card identification information of the IC card of the previous time of use. And the carried over amount associated with the card identification information of the IC card of the previous time of use becomes unusable.

Meanwhile, when an input of a phone number of a mobile phone is accepted (Yes in S112), the input information acquisition unit 13 acquires the input phone number, in association with the card identification information acquired in S101. After that, the authentication process using a mobile phone is performed (S113). Contents of the authentication process are similar to the authentication process described in the “process at a time of entry for a first time use”.

When the authentication fails (No in S114), the registration unit 14 performs the error process (S118). For example, information indicating that the authentication has failed is displayed on the screen, the screen such as illustrated in FIG. 6 (C) is also displayed, and a re-input of the phone number is prompted. Then, the process returns to S112, and is repeated.

Meanwhile, when the authentication succeeds (Yes in S114), the registration unit 14 confirms whether the phone number accepted in S112 is registered in the user information such as illustrated in FIG. 9 (S115).

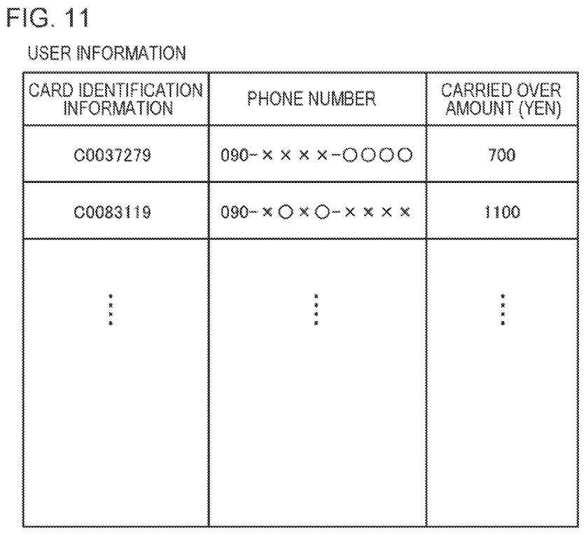

In the case of a second and subsequent time of use where the IC card different from the previous time of use is used and the phone number has already been registered at a previous time of use up to that point, the phone number of the user is registered in the user information. Therefore, S115 results in Yes, and the process proceeds to S116. In S116, the registration unit 14 updates, in the user information such as illustrated in FIG. 9, the card identification information being registered in association with the phone number acquired in S112 to the card identification information acquired in S101. As a result, for example, the user information illustrated in FIG. 9 is updated to user information illustrated in FIG. 11. When the user information in FIG. 9 and the user information in FIG. 11 are compared, it is understood that the card identification information associated with the phone number “090_xxxx-oOOO” is updated from “C1131923” to “C0037279”.

Note that, even in the case of a second time and subsequent use where the IC card different from the previous time of use is used, the phone number of the user is not registered in the user information unless the user has registered the phone number at a previous time of use up to that point. Therefore, S115 results in No, and the process proceeds to S117. In S117, the registration unit 14 newly registers, in the user information such as illustrated in FIG. 9, the card identification information acquired in S101 and the phone number accepted in S112, in association with each other. Note that, an initial value of a carried over amount is “0”. In this case, the card identification information of the IC card of the present time of use is registered separately from the card identification information of the IC card of the previous time of use. Then, the carried over amount associated with the card identification information of the IC card of the previous time of use becomes unusable.

In S104, the registration unit 14 determines whether the card identification information acquired in S101 has already been registered in the usage state information. In the case of the process at a time of entry, the card identification information is not registered in the usage state information. Therefore, S104 results in No, and the process proceeds to the entry process in S106. Contents of the entry process in S106 is similar to the entry process described in the “process at a time of entry for a first time use”.

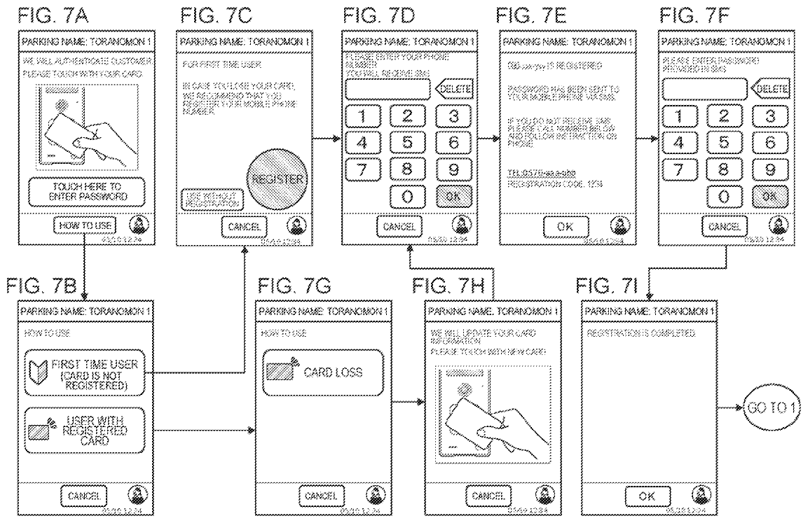

Note that, herein, a user holds the IC card to be used in the present time of use to the reader/writer of the accounting apparatus 100 via a screen illustrated in FIG. 6 (A), however, the user may follow the following flow. First, a user touches “how to use” in a screen illustrated in FIG. 7 (A) (which is the same as the screen illustrated in FIG. 6 (A)) and the screen changes to a screen in FIG. 7 (B), and then touches “user with registered card” and the screen changes to a screen in FIG. 7 (G). Then, after the user touches “card loss” in the screen and the screen changes to a screen in FIG. 7 (H), the process proceeds in a similar way as above-described example, following a flow of FIG. 7 (D), FIG. 7 (E), FIG. 7 (F), and FIG. 7 (I).

### “Process at a Time of Exit”

When exiting the parking lot, a user operates the accounting apparatus 100 installed at any location in the parking lot. The accounting apparatus 100 displays the screen in FIG. 6 (A), and is in the operation standby state. The user holds, to the reader/writer of the accounting apparatus 100, the IC card that the user has held to the accounting apparatus 100 at the time of entry. Then, the input information acquisition unit 13 acquires, via the reader/writer unit 11, the card identification information stored in the IC card (S101 in FIG. 3).

Next, the registration unit 14 determines whether the card identification information acquired in S101 has already been registered in the user information (S102). The card identification information of the IC card has been registered, at the time of entry, in the user information. Therefore, S102 results in Yes, and the process proceeds to S103.

Next, the registration unit 14 determines whether a phone number is registered in association with the card identification information acquired in S101, in the user information such as illustrated in FIG. 9 (S103). When the phone number has already been registered (Yes in S103), the process proceeds to S104.

Meanwhile, when no phone number is registered (No in S103), the accounting apparatus 100 displays a screen that prompts registration of a phone number of a mobile phone, as illustrated in FIG. 6 (G). Note that, registration of a phone number of a mobile phone is optional and is not necessary.

When an input of a phone number of a mobile phone is not accepted (No in S107), the process proceeds to S104. Meanwhile, when an input of a phone number of a mobile phone is accepted (Yes in S107), the input information acquisition unit 13 acquires the input phone number, in association with the card identification information acquired in S101. After that, an authentication process using a mobile phone is performed (S108). Contents of the authentication process are similar to the authentication process in S113 described in the “process at a time of entry for a first time use”.

When the authentication fails (No in S109), the registration unit 14 performs the error process (S111). For example, information indicating that the authentication has failed is displayed on the screen, the screen such as illustrated in FIG. 6 (C) is also displayed, and a re-input of the phone number is prompted. Then, the process returns to S107, and is repeated.

Meanwhile, when the authentication succeeds (Yes in S109), the registration unit 14 registers, in the user information such as illustrated in FIG. 9, the input phone number, in association with the card identification information acquired in S101 (S110). Then, the process proceeds to S104.

In S104, the registration unit 14 determines whether the card identification information acquired in S101 has already been registered in the usage state information. In the case of the process at a time of exit, the card identification information is registered in the usage state information. Therefore, S104 results in Yes, and the process proceeds to an exit process in S105.

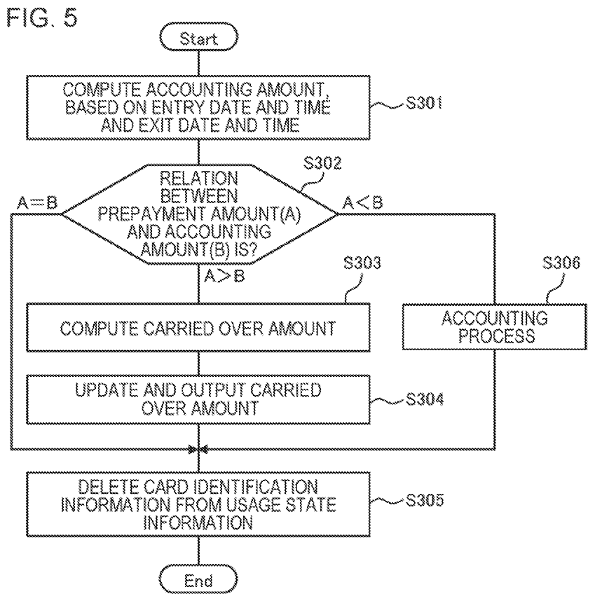

Hereinafter, a flow of the exit process in S105 is described by using a flowchart in FIG. 5.

The determination unit 17 acquires an entry date and time registered in association with the card identification information acquired in S101 in FIG. 3 in the use state information such as illustrated in FIG. 10, and computes an accounting amount, based on the entry date and time and an exit date and time (S301). The exit date and time is a time at a timing when the input of the card identification information is accepted in S101 at the time of exit, or a time at any timing after that.

In a case where a prepayment amount (A) exceeds an accounting amount (B) (“A>B” in S302), the accounting unit 18 computes an carried over amount being an excess amount (S303). Then the accounting unit 18 registers (updates), via the registration unit 14, in the user information such as illustrated in FIG. 9, the computed carried over amount, in association with the card identification information acquired in S101 (S304). Also, the accounting unit 18 outputs the computed carried over amount in such a way as to be visually recognizable for a user (S304). The accounting unit 18 may cause the carried over amount to be displayed on a display of the accounting apparatus 100. For example, the accounting apparatus 100 may display a screen such as illustrated in FIG. 8 (F). Then, the accounting unit 18 deletes the card identification information acquired in S101 from the user information such as illustrated in FIG. 10, via the registration unit 14 (S305).

Note that, in a case where the prepayment amount (A) matches the accounting amount (B) (“A=B” in S302), the accounting unit 18 deletes the card identification information acquired in S101 from the user information such as illustrated in FIG. 10, via the registration unit 14 (S305).

Further, in a case where the prepayment amount (A) is less than the accounting amount (B) (“A<B” in S302), the accounting unit 18 executes accounting process in which payment for a shortage amount is accepted (S306). For example, the accounting unit 18 computes a shortage amount, and outputs information that asks a user to pay for the shortage amount. For example, the accounting apparatus 100 displays a screen such as illustrated in FIG. 8 (G), notifies the shortage amount (“payment amount” in FIG. 8 (G)), and also displays a screen that prompts holding the IC card to the reader/writer of the accounting apparatus 100. In response to this, when the IC card is held to the reader/writer of the accounting apparatus 100 and the accounting apparatus 100 and the IC card become a state in communicable, the accounting unit 18 updates the electronic money information stored in the IC card, via the reader/writer unit 11, and subtract the predetermined amount from the electronic money balance. Then, the accounting unit 18 deletes the card identification information acquired in S101 from the user information such as illustrated in FIG. 10, via the registration unit 14 (S305).

According to the above-described accounting apparatus 100, it is possible to ask a user to prepay a usage fee and register a carried over amount acquired by subtracting an accounting amount from a prepayment amount. Further, according to the accounting apparatus 100, it is possible to notify a user of a carried over amount to be registered. Further, according to the accounting apparatus 100, it is possible to use a carried over amount to pay for a next time of use. Further, according to the accounting apparatus 100, even in a case where an IC card different from a previous time of use is used, when a phone number is registered, it is possible to update user information by using the phone number (FIG. 9→FIG. 11) and use a carried over amount that has been generated when another IC card is used. Further, by capturing an image of a parking lot, and determining and managing a vehicle of each user, it is possible to perform verification and the like of a fraudulent use, as well as use as evidence of a fraudulent use. In this way, according to the accounting apparatus 100, high convenience is achieved.

Herein, a modification example according to the present example embodiment is described. Another piece of information such as a name, a nickname, a number of a driver's license, a national identification number, and the like may be used in place of a phone number (user identification information) of a mobile phone used in the above-described example. In this case, the authentication process by using a mobile phone used in the above-described example cannot be performed, but the authentication may be performed by other means, or the authentication may be eliminated.

Further, in the above-described example, an input and registration of a vehicle number are required, but this process may be eliminated. Further, in the above-described example, specifying and registering a vehicle in an image is required, but this process may be eliminated.

Further, the accounting apparatus 100 may include a camera for capturing a customer operating the accounting apparatus 100. Further, the accounting apparatus 100 may be capable of registering face information (a face image or a feature value generated from a face image) of a customer in the user information (see FIG. 9), in association with the card identification information. For example, the accounting apparatus 100 may accept capturing and registration of a face image at a timing before or after accepting the registration of a phone number in the flow of the above-described process, or at any other timing.

Further, the accounting apparatus 100 may capture a face of a customer and perform face authentication before the customer holds an IC card to the reader/writer of the accounting apparatus 100 in FIG. 6 (A) and the like. For example, the accounting apparatus 100 may detect, by using a motion sensor and the like, a person standing in front of the accounting apparatus 100 and automatically capture a picture in response to the detection, or may capture a picture in response to a manual operation by a customer.

Further, when the face authentication succeeds, the accounting apparatus 100 may execute the process in and after S101 in FIG. 3, without an operation in which a customer holds the IC card to the reader/writer of the accounting apparatus 100. In this case, in S101, the accounting apparatus 100 reads the card identification information of the customer who has been successfully authenticated from the user information (see FIG. 9), and executes the process in and after S102, based on the read card identification information.

Meanwhile, when the face authentication fails, accounting apparatus 100 displays the screen such as illustrated in FIG. 6 (A), and accepts an operation in which a customer holds the IC card to the reader/writer of the accounting apparatus 100 (S101 in FIG. 3).

### Second Example Embodiment

An accounting apparatus 100 according to the present example embodiment is different from the first example embodiment in a point that the accounting apparatus 100 has a function of presenting various functions in response to an operation by an administrator (a side providing a service such as a parking lot).

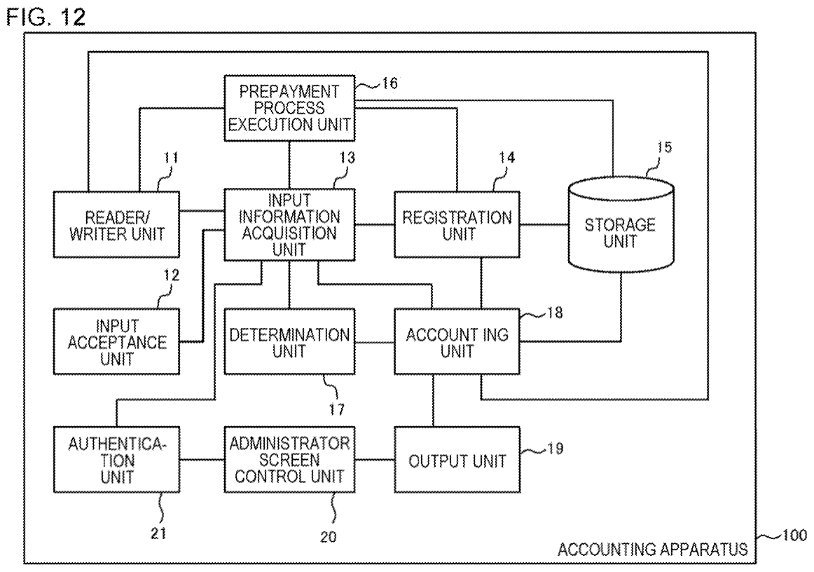

One example of a functional block diagram of the accounting apparatus 100 is illustrated in FIG. 12. As illustrated, the accounting apparatus 100 includes a reader/writer unit 11, an input acceptance unit 12, an input information acquisition unit 13, a registration unit 14, a storage unit 15, a prepayment process execution unit 16, a determination unit 17, an accounting unit 18, an output unit 19, an administrator screen control unit 20, and an authentication unit 21.

Configurations of the reader/writer unit 11, the input acceptance unit 12, the input information acquisition unit 13, the registration unit 14, the storage unit 15, the prepayment process execution unit 16, the determination unit 17, and the accounting unit 18 are similar to those of the first example embodiment.

The authentication unit 21 executes an authentication process based on administrator identification information and a password. When the authentication succeeds, the administrator screen control unit 20 outputs, via the output unit 19, an administrator screen.

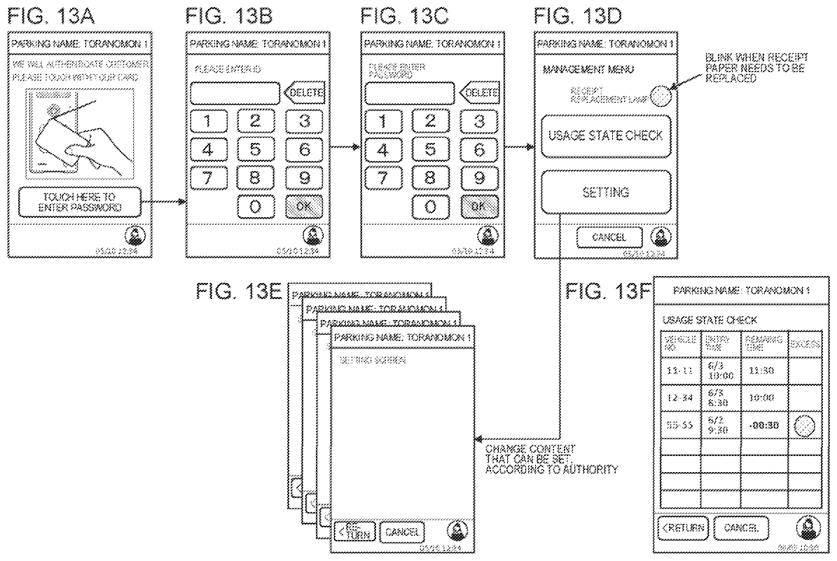

Next, one example of a flow of processing achieved by the above-described functional units is described by using screen examples in FIG. 13. Herein, a case where the accounting apparatus 100 is used in a parking lot is described as an example.

The accounting apparatus 100 displays a screen in FIG. 13 (A) and is in an operation standby state. When an administrator touches “touch here to enter password”, the screen changes to FIG. 13 (B), and then to FIG. 13 (C). The input information acquisition unit 13 acquires, via the input acceptance unit 12, administrator identification information and a password, which are input via those screens. Then, the authentication unit 21 executes an authentication process based on the administrator identification information and the password. The authentication is achieved by checking a combination of pre-registered administrator identification information and a pre-registered password of a legitimate authorized person against a combination of the acquired administrator identification information and the acquired password. The check may be performed by the authentication unit 21, or may be performed by a server configured in such a way as to be communicable with the accounting apparatus 100. The combination of the administrator identification information and the password of the legitimate authorized person is stored in a storage unit of a subject performing the check.

When the check is performed by a server, the authentication unit 21 performs the authentication process in which the combination of the acquired administrator identification information and the acquired password is transmitted to the server and a check result is acquired from the server.

When the authentication fails, the authentication unit 21 performs an error process. For example, the authentication unit 21 displays, via the output unit 19, information indicating that the authentication has failed, on a screen, and again displays the screens such as illustrated in FIG. 13 (B) and FIG. 13 (C), and accepts a re-input of administrator identification information and a password.

Meanwhile, when the authentication succeeds, the administrator screen control unit 20 outputs an administrator screen, via the output unit 19. The accounting apparatus 100 displays, for example, screens such as illustrated in FIG. 13 (D), FIG. 13 (E), and FIG. 13 (F).

The administrator screen control unit 20 may display, as illustrated in FIG. 13 (D), information indicating whether a receipt needs to be replenished, in the administrator screen.

Further, the administrator screen control unit 20 may display, as illustrated in FIG. 13 (F), information indicating a usage state of the parking lot, on the administrator screen. The screen is prepared, based on usage state information such as illustrated in FIG. 10. An illustrated “remaining time” indicates a time remaining in a time from an entry date and time until a time at which a time for a prepayment amount elapses. When the time for prepayment amount has already elapsed, an elapsed time is indicated by using a minus sign. An excess flag indicates whether a time from an entry date and time until a time at which a time for the prepayment amount has already elapsed.

Note that, it may be possible to transmit the information (see FIG. 13 (F)) indicating the usage state of the parking lot to an administrator's terminal by using any wired and/or wireless communication means. For example, the administrator's terminal and the accounting apparatus 100 may communicate with each other via short-range wireless communication. In addition, the administrator's terminal and the accounting apparatus 100 may be connected to each other via wired connection. In addition, when an email address is input to the accounting apparatus 100, the information indicating a usage state of the parking lot may be transmitted to the email address.

Further, the administrator screen control unit 20 may display, as illustrated in FIG. 13 (E), a setting screen for changing various settings, on the administrator screen. For example, a setting authority level is registered in association with each piece of the administrator identification information, and based on a registered content, a content that can be set in the setting screen displayed when each administrator logs in may be controlled.

Note that, other configurations of the accounting apparatus 100 are similar to those of the first example embodiment.

According to the accounting apparatus 100 according to the present example embodiment, an advantageous effect similar to the first example embodiment can be achieved. Further, according to the accounting apparatus 100 according to the present example embodiment, it is possible to accept not only a user operation but also an operation from an administrator, and it is possible to output information for the administrator. Since an operation from a user and an operation from an administrator can be accepted by a single apparatus, high convenience is achieved.

Herein, a modification example according to the present example embodiment is described. The authentication using the administrator identification information and the password is performed in the above-described example, but the authentication may be replaced with biometric authentication using biometric information such as a face image, a fingerprint, a voice print, an iris, and the like.

Herein, a modification example being applicable to all the example embodiments. As described above, the accounting apparatus 100 according to the present example embodiment can be used in all kinds of situations, including a parking lot, a rental office, a shared bicycle, a shared car, a battery charge service, a restaurant, an amusement such as bowling, a supermarket, a convenience store, a vending machine, a gas station, and the like, and the user information (see FIG. 9) may be managed for each business operator of each service, or one piece of the user information may be collectively managed among a plurality of business operators. When one piece of the user information is collectively managed among a plurality of business operators, the user information referred by the accounting device 100 at a time of accounting for a parking lot and the user information referred by the accounting device 100 at a time of accounting for a rental office are the same information. In this case, for example, it is possible to use a carried over amount being generated in a use of the parking lot at a time of using other services such as the rental office. Further, when the card identification information and a phone number are registered at a time of using the parking lot, registration at a time of using other services such as the rental office is not required.

Further, a carried over amount may be useable in a place other than a store or a facility where an accounting amount is determined in response to contents of use and is not determined at a beginning of use. An example includes a vending machine and the like, but is not limited thereto. In this case, when a payment apparatus reads, at a time of paying a predetermined amount, information of an IC card with which the carried over amount is associated in user information (see FIG. 9), the payment apparatus refers to the user information, and confirms presence or absence of the carried over amount. Then, when the carried over amount is present, the payment apparatus prioritize use of the carried over amount for payment.

Further, the case where the electronic money information storage apparatus is an IC card is described as an example in the above-described, but the electronic money information storage apparatus may be another apparatus such as an IC tag, a smartphone, a mobile phone, a tablet terminal, and a smartwatch. Apparatus identification information in this case may be information that identifies each individual apparatus, or user identification information of an electronic money service stored in each apparatus.

Note that, in the present description, “acquisition” includes at least one of “retrieving data stored in another apparatus or a storage medium by own apparatus (active acquisition)”, based on an input from a user or an instruction by a program, which is, for example, receiving data by requesting or inquiring another apparatus, reading data by accessing another apparatus or a storage medium, and the like, “inputting data being output from another apparatus to the own apparatus (passive acquisition)”, based on an input from a user or an instruction by a program, which is, for example, standing by in a state where data transmitted from an external apparatus can be received and receiving the data transmitted from the external apparatus, receiving data delivered (or transmitted, notified by a push notification, or the like) from an external apparatus, and selecting and acquiring data or information from among the received data or information, and “generating new data by editing data (converting into text, reordering the data, extracting some of the data, changing a file format, and the like), and acquiring the new data”.

A part or the whole of the above-described example embodiments may also be described in supplementary notes below, but is not limited thereto.

1. An accounting apparatus, including:

an input information acquisition means for acquiring apparatus identification information stored in an electronic money information storage apparatus;

a prepayment process execution means for executing a prepayment process in which a predetermined amount is subtracted from an electronic money balance, based on electronic money information stored in the electronic money information storage apparatus;

a registration means for registering, when a prepayment amount exceeds an accounting amount, a carried over amount being an excess amount and the apparatus identification information, in association with each other; and

an accounting means for performing an accounting process in which the carried over amount is output in such a way as to be visually recognizable for a user.

2. The accounting apparatus according to supplementary note 1, wherein

the input information acquisition means acquires user identification information, in association with the apparatus identification information, and

the registration means
registers, when the user identification information is not registered, the user identification information, in association with the apparatus identification information, and
updates, when the user identification information has already been registered, the apparatus identification information registered in association with the user identification information to the acquired apparatus identification information.
   3. The accounting apparatus according to supplementary note 1 or 2, wherein

the input information acquisition means acquires the prepayment amount specified by a user, and

the prepayment process execution means computes the predetermined amount, based on the prepayment amount specified by a user and the carried over amount registered in association with the apparatus identification information.

4. The accounting apparatus according to any one of supplementary notes 1 to 3, wherein,

when the prepayment amount is less than the accounting amount, the accounting means performs the accounting process in which payment for a shortage amount is accepted.

5. The accounting apparatus according to any one of supplementary notes 1 to 4, wherein

the input information acquisition means acquires administrator identification information and a password, and

the accounting apparatus further including:

an authentication means for executing an authentication process based on the administrator identification information and the password; and

an administrator screen control means for outputting, when authentication succeeds, an administrator screen.

6. The accounting apparatus according to supplementary note 5, wherein

the administrator screen control means displays information indicating whether a receipt needs to be replenished, in the administrator screen.

7. The accounting apparatus according to any one of supplementary notes 1 to 6, wherein,

as a process at a time of entry to a parking lot,
the input information acquisition means acquires the apparatus identification information, and
the prepayment process execution means performs the prepayment process and registration of the prepayment amount, and

as a process at a time of exit from a parking lot,
the input information acquisition means acquires the apparatus identification information, and
the accounting means executes the accounting process, based on the prepayment amount registered in association with the apparatus identification information, and the accounting amount.
   8. The accounting apparatus according to supplementary note 7 being dependent to supplementary note 5 or 6, wherein

the administrator screen control means displays information indicating a usage state of a parking lot, in the administrator screen.

9. An accounting method, including:

by a computer,

acquiring apparatus identification information stored in an electronic money information storage apparatus;

executing a prepayment process in which a predetermined amount is subtracted from an electronic money balance, based on electronic money information stored in the electronic money information storage apparatus;

registering, when a prepayment amount exceeds an accounting amount, a carried over amount being an excess amount and the apparatus identification information, in association with each other; and

performing an accounting process in which the carried over amount is output in such a way as to be visually recognizable for a user.

10. A program causing a computer to function as:

an input information acquisition means for acquiring apparatus identification information stored in an electronic money information storage apparatus;

a prepayment process execution means for executing a prepayment process in which a predetermined amount is subtracted from an electronic money balance, based on electronic money information stored in the electronic money information storage apparatus;

a registration means for registering, when a prepayment amount exceeds an accounting amount, a carried over amount being an excess amount and the apparatus identification information, in association with each other; and

an accounting means for performing an accounting process in which the carried over amount is output in such a way as to be visually recognizable for a user.

While the invention of the present application has been described with reference to the example embodiments (and practical examples), the invention of the present application is not limited to the above-described example embodiments (and practical examples). Various changes that can be understood by a person skilled in the art can be made to a configuration and details of the invention of the present application without departing from the scope of the invention of the present application.

This application is based upon and claims the benefit of priority from Japanese patent application No. 2019-127813, filed on Jul. 9, 2019, the disclosure of which is incorporated herein in its entirety by reference.

### REFERENCE SIGNS LIST

1A Processor
2A Memory
3A Input/output I/F
4A Peripheral circuit
5A Bus
100 Accounting apparatus
11 Reader/writer unit
12 Input acceptance unit
13 Input information acquisition unit
14 Registration unit
15 Storage unit
16 Prepayment process execution unit
17 Determination unit
18 Accounting unit
19 Output unit
20 Administrator screen control unit
21 Authentication unit

What is claimed is:

1. An accounting apparatus, comprising:
at least one memory configured to store one or more instructions; and
at least one processor configured to execute the one or more instructions to:
acquire apparatus identification information stored in an electronic money information storage apparatus;
execute a prepayment process in which a predetermined amount is subtracted from an electronic money balance, based on electronic money information stored in the electronic money information storage apparatus;
register, when a prepayment amount exceeds an accounting amount, a carried over amount being an excess amount and the apparatus identification information, in association with each other; and
perform an accounting process in which the carried over amount is output in such a way as to be visually recognizable for a user.

2. The accounting apparatus according to claim 1, wherein the processor is further configured to execute the one or more instructions to:
acquire user identification information, in association with the apparatus identification information,
register, when the user identification information is not registered, the user identification information, in association with the apparatus identification information, and
update, when the user identification information has already been registered, the apparatus identification information registered in association with the user identification information to the acquired apparatus identification information.

3. The accounting apparatus according to claim 1, wherein the processor is further configured to execute the one or more instructions to:
acquire the prepayment amount specified by a user, and
compute the predetermined amount, based on the prepayment amount specified by a user and the carried over amount registered in association with the apparatus identification information.

4. The accounting apparatus according to claim 1,
wherein the processor is further configured to execute the one or more instructions to perform the accounting process in which payment for a shortage amount is accepted, when the prepayment amount is less than the accounting amount.

5. The accounting apparatus according to claim 1, wherein the processor is further configured to execute the one or more instructions to:
acquire administrator identification information and a password,
execute an authentication process based on the administrator identification information and the password; and
output, when authentication succeeds, an administrator screen.

6. The accounting apparatus according to claim 5, wherein the processor is further configured to execute the one or more instructions to display information indicating whether a receipt needs to be replenished, in the administrator screen.

7. The accounting apparatus according to claim 1, wherein wherein the processor is further configured to execute the one or more instructions to:
as a process at a time of entry to a parking lot, acquire the apparatus identification information, and perform the prepayment process and registration of the prepayment amount, and
as a process at a time of exit from a parking lot, acquire the apparatus identification information, and the accounting execute the accounting process, based on the prepayment amount registered in association with the apparatus identification information, and the accounting amount.

8. The accounting apparatus according to claim 5, wherein the processor is further configured to execute the one or more instructions to display information indicating a usage state of a parking lot, in the administrator screen.

9. An accounting method, comprising:
by a computer,
acquiring apparatus identification information stored in an electronic money information storage apparatus;
executing a prepayment process in which a predetermined amount is subtracted from an electronic money balance, based on electronic money information stored in the electronic money information storage apparatus;
registering, when a prepayment amount exceeds an accounting amount, a carried over amount being an excess amount and the apparatus identification information, in association with each other; and
performing an accounting process in which the carried over amount is output in such a way as to be visually recognizable for a user.

10. A non-transitory storage medium storing a program causing a computer to:
acquire apparatus identification information stored in an electronic money information storage apparatus;
execute a prepayment process in which a predetermined amount is subtracted from an electronic money balance, based on electronic money information stored in the electronic money information storage apparatus;
register, when a prepayment amount exceeds an accounting amount, a carried over amount being an excess amount and the apparatus identification information, in association with each other; and
perform an accounting process in which the carried over amount is output in such a way as to be visually recognizable for a user.
